(19) United States
(12) Patent Application Publication
(10) Pub. No.: US 2024/0272613 A1
(43) Pub. Date: Aug. 15, 2024

(54) 3D PRINTING OBJECTS IN LAYERS SEPARATED BY REMOVABLE MATERIAL

(71) Applicant: International Business Machines Corporation, Armonk, NY (US)

(72) Inventors: Alan Chung, Hopewell Junction, NY (US); Jeremy R. Fox, Georgetown, TX (US); Mauro Marzorati, Lutz, FL (US); Sarbajit K. Rakshit, Kolkata (IN)

(21) Appl. No.: 18/168,604

(22) Filed: Feb. 14, 2023

(51) Int. Cl. G05B 19/4099

(52) U.S. Cl. CPC G05B 19/4099; G05B 2219/49023

(57) ABSTRACT

A method, system, and computer program product generate a layout plan for printing three-dimensional (3D) objects and provide the layout plan to a controller of a 3D printer. Generating the layout plan comprises receiving, at a computer-implemented design module, a virtual model representing the objects and selecting an object material for printing the objects. Generating the layout plan also includes, by the design module, selecting, based on the object material and the virtual model, an isolation material to be deposited on adjacent surfaces of the objects and generating a virtual model arrangement of the objects and the isolation material. The controller of the 3D printer directs the 3D printer to print an arrangement of the objects and the isolation material according to the layout plan.

### BACKGROUND

The present disclosure relates to additive manufacturing and, more specifically, to printing physical objects separated by a removable material based on a virtual layout model.

Three-dimensional (3D) printing technology, also known as additive manufacturing, can be used to fabricate 3D physical objects by forming/depositing a material based on a 3D virtual model of the physical object(s). The model may logically slice a virtual representation of the physical object into several layers and provide instructions to the printer. The instructions control the machine, and more specifically the printhead of the machine, to deposit each layer successively until the physical object is completed. The physical objects fabricated through 3D printing processes can have a variety of shapes and geometries and are widely used in a variety of industries and applications. However, fabricating large numbers of objects by current printing techniques can be expensive and time consuming, creating a need for improved efficiency.

### SUMMARY

Various embodiments are directed to a method that includes generating, by a computer-implemented design module, a layout plan for printing three-dimensional (3D) objects. Generating the layout plan comprises receiving a virtual model representing the objects and selecting an object material for printing the objects. Generating the layout plan also includes selecting, based on the object material and the virtual model, an isolation material to be deposited on adjacent surfaces of the objects to separate them. Further, generating the layout plan includes generating a virtual model arrangement of the objects and the isolation material. Generating the layout plan may provide advantages such as designs for more efficient manufacturing. These designs may take into account variables, such as centers of mass, related to stability of printed arrangements. For example, generating the arrangement may include selecting a number of objects to be printed in a virtual stack based on a predicted stability.

The method also includes providing the layout plan to a controller of a 3D printer. The controller of the 3D printer directs the 3D printer to print an arrangement of the objects and the isolation material according to the layout plan. In doing so, the controller may advantageously direct the printer to manufacture objects efficiently in a manner that is compatible with current 3D printing technology. For example, the object material can be a thermoplastic, and the isolation material may be calcium carbonate or polyvinyl acetate. The method may also include removing the objects from the arrangement, e.g., by dissolving the isolation material, applying ultrasonic vibrations, or applying a water jet. The removal may further streamline the process of 3D printing and allow separation of the objects printed in one cycle. In some embodiments, the removed isolation material is collected and reused in a next print cycle. This can lower the cost of manufacturing the objects and reduce waste production.

Further embodiments are directed to a system, which includes a 3D printer, a memory, and a processor communicatively coupled to the memory, wherein the processor is configured to perform the method. Additional embodiments are directed to a computer program product, which includes a computer readable storage medium having program instructions embodied therewith, the program instructions executable by a processor to cause a device to perform the method.

The above summary is not intended to describe each illustrated embodiment or every implementation of the present disclosure.

### BRIEF DESCRIPTION OF THE DRAWINGS

The drawings included in the present disclosure are incorporated into, and form part of, the Specification. They illustrate embodiments of the present disclosure and, along with the description, serve to explain the principles of the disclosure. The drawings are only illustrative of typical embodiments and do not limit the disclosure.

FIG. 1 is a block diagram illustrating a computing environment, according to some embodiments.

FIG. 2 is a block diagram illustrating a 3D printing environment, according to some embodiments.

FIG. 3 is a flowchart illustrating a process of printing an arrangement of 3D objects and isolation material, according to some embodiments.

FIG. 4 is a schematic diagram illustrating an arrangement of printed objects and isolation material, according to some embodiments.

### DETAILED DESCRIPTION

Aspects of the present disclosure relate generally to additive manufacturing and, more specifically, to using a segmented three-dimensional (3D) model to control printing of multiple objects separated by removable layers. While the present disclosure is not necessarily limited to such applications, various aspects of the disclosure may be appreciated through a discussion of various examples using this context.

Additive manufacturing techniques, such as 3D printing, can be used to make physical objects from a digital file. For example, a virtual model of an object to be printed is a process of making three dimensional objects from a digital file. The creation of a 3D printed object is achieved using additive processes. In an additive process an object is created by laying down successive layers of material until the object is created. Each of these layers can be seen as a thinly sliced horizontal cross-section of the eventual object.

Different types of physical objects can be printed with a 3D printer, and different types of material can be used by 3D printing machines; the material properties are selected based on type of work product to be created. Some of the material can be very hard, some can be elastic, some can be brittle, etc. In conventional 3D printing, a 3D printer prints a single object at a time. After an object is printed, then a manual or robotic system removes the printed object from the printer and makes the 3D printer ready for next object to be printed. After completion of the object, the printing head stops so the object that is already printed can be taken out. Alternately, if the 3D printer head moves in another position for printing the next object.

However, aspects of conventional 3D printing can be inefficient. For example, in most 3D printers, the printing head stops after printing an object and changes position before printing a next object. Reducing idle time between object printing may reduce costs and allow more efficient manufacturing. Embodiments of the present disclosure may address these and other challenges.

For example, multiple objects may be printed in a single print cycle (e.g., without stopping the print head(s) between printing of subsequent objects) according to a virtual 3D model generated by a computer-aided design (CAD) program or other modeling technique. Printing multiple objects in one print cycle may provide increased productivity and efficiency by allowing shared overhead (e.g., start up, model loading, warm up, head change, etc.). A primary printing head may be used to print the objects. A secondary printing head may be used to print a secondary material that acts as an isolation layer between adjacent objects. The secondary material may also act as a support structure for the objects during the printing cycle.

The virtual model may provide an arrangement in which to print the objects that conserves space and utilizes the secondary material as a barrier between the printed objects. The secondary material may isolate and, in some embodiments, support adjacent objects during the printing. When the objects have been printed, the secondary material can be removed. Removing the secondary material may be accomplished using techniques that will not damage or otherwise alter the printed objects. The removal techniques may be varied based on the types of objects/materials used in various embodiments. In some embodiments, the secondary material will not substantially adhere or bind to the material(s) used to form the printed objects.

In further embodiments, the model may optimize printing parameters based on the object structures. For example, the objects may be printed with minimal gaps between them in order to, for example, conserve movement of the printing head(s) and secondary material usage. Other parameters may include programmed movements of a base on which the objects are printed. For example, the base may be automatically lowered as objects are completed. In some embodiments, completed objects can be automatically removed from the 3D printing chamber before being separated. The completed objects may be separated from the secondary material while a second print cycle begins in the vacated 3D printing chamber. In some embodiments, the secondary material is collected after separation and reused in subsequent print cycles. In other embodiments, the secondary material may be discarded.

The aforementioned advantages are example advantages and should not be construed as limiting. Embodiments of the present disclosure can contain all, some, or none of the aforementioned advantages while remaining within the spirit and scope of the present disclosure.

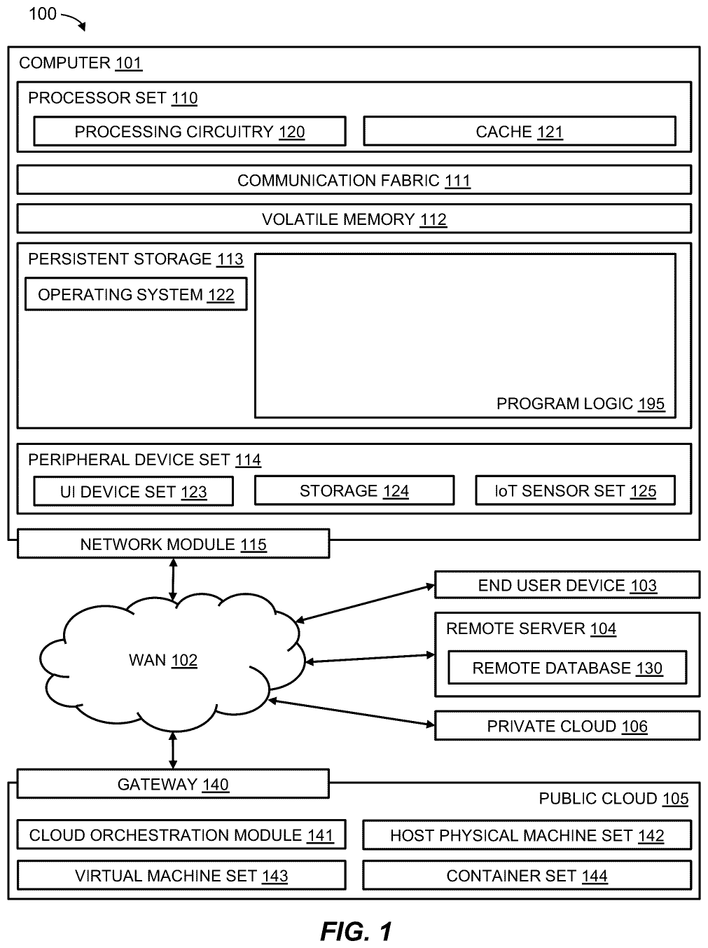

Turning now to the figures, FIG. 1 is a block diagram illustrating a computing environment 100, according to some embodiments of the present disclosure. Computing environment 100 contains an example of a program logic 195 for the execution of at least some of the computer code involved in performing the inventive methods, such as generating virtual models and/or controlling printer operations. In addition to block 195, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 195, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 195 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 195 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

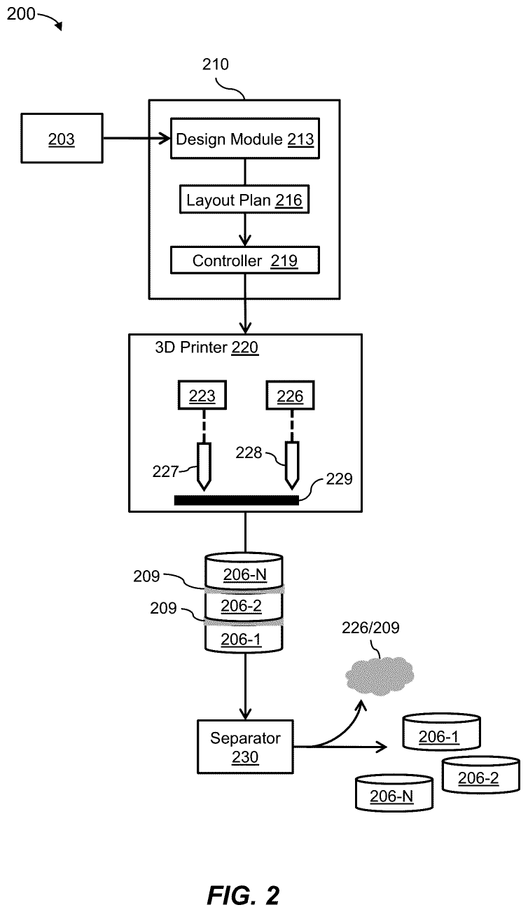

FIG. 2 is a block diagram illustrating a 3D printing environment 200, according to some embodiments. A virtual 3D model 203 of an object to be printed can be input into a computing apparatus 210 that can include a design module 213, such as a computer-aided design (CAD) module. In some embodiments, the computing apparatus 210 is the same as, or substantially similar to, the computer 100 illustrated in FIG. 1. The design module 213 may generate a layout plan 216 for printing N copies of the object, where N is an integer greater than 1. In some embodiments, artificial intelligence (AI) or other machine learning (ML) techniques are used by the design module 213 to generate the layout plan 116 based on input information including the virtual model 203.

While a single virtual model 203 is illustrated in FIG. 2, virtual models of two or more objects with different features (e.g., differences in shape, size, mass, dimensions, materials, etc.) may be input into the design module 213. In these instances, the design module 213 can generate a layout plan 216 that includes a given number of copies of each object to be printed using substantially the same or similar techniques as with one object, while taking into account the variations between the objects.

The layout plan 216 can be an object design document, which may be provided to a user by an external creator as a software file, or set of files, on portable non-volatile storage and loaded to computing apparatus 210, or it may be downloaded from an external network. In some embodiments, the layout plan 216 may be created by the user on computing apparatus 210 using CAD software (e.g., design module 213) loaded into volatile storage.

Other information that may be input into the layout plan 216 by a user and/or from another source (e.g., preset parameters, knowledge corpus, etc.) may include material selections and any other parameters for 3D printing. The material selections can indicate at least one material (“object material 223”) for printing copies of the object (e.g., the object represented by the virtual model 203) and at least one material (“isolation material 226”) for printing, or otherwise depositing, layers, structures, regions, components, etc., that isolate adjacent objects printed in one print cycle. In FIG. 2, layers (“isolation layers 209”) of the isolation material 226 are shown separating the printed objects 206-1, 206-2, . . . , 206-N (collectively “printed objects 206”). The isolation material 226 selection may be suggested by the design module 213 (e.g., based on the layout plan 216, object material 223, type of printer 220, etc.) and/or input by a user.

The layout plan 216 can be provided to a 3D printer controller (“controller”) 219 in communication with a 3D printer 220. Controller 219 may include any appropriate software for 3D printing operations. Controller 219 may utilize an object design document (e.g., layout plan 216) to generate a sequence of operational signals to control the movement of printer head assemblies and, optionally, a moveable build plate, robotic arm(s), a conveyor belt, etc. If the layout plan 216 indicates that time is needed for curing the object material 223 and/or isolation material 226, the controller 219 may pause between printing objects and layers.

The 3D printer 220 can have first 227 and second 228 printer head assemblies. In some embodiments, the head assemblies 227 and/or 228 may include printing nozzles at the ends of material feed tubes (not shown) through which the object material 223 or the isolation material 226 may respectively be delivered. In some embodiments, the build plate 229 may be lowered during a print cycle in order to print a vertical stack of objects 206 separated by the isolation layers 209. Any appropriate type of head assemblies 227 and 228 (or other components for depositing material) may be used, depending on what is being printed/deposited. In some embodiments, the materials 223 and 226 may be independently selected from, e.g., plastics, minerals, metals, gels, oils, etc., and may be loaded into the 3D printer 220 in forms such as filaments, powders, liquids, particles, etc.

The isolation material 226 may be selected (e.g., by the design module 213 or a user) based on properties such as stability and compatibility with the object material 223. The isolation material 226 can be any suitable material for forming a spacer or inert surface between adjacent objects, e.g., a material that can be removed without causing damage or undesired alterations to the objects. For example, when the printed arrangement is complete, an appropriate solvent may be used to dissolve the isolation material 226 of the layers 209 without damaging the finished objects 206.

For example, object material 223 can be a thermoplastic (e.g., acrylonitrile butadiene styrene (ABS), nylon, polystyrene, polylactic acid (PLA), etc.). In these instances, the first print head 227 may include a heating mechanism (not shown), such as an electrical resistance heating element, over which a filament (object material 223) is passed. In some embodiments, object material 223 may be fed into the print head 227 as a 3 mm diameter filament, but any suitable material, delivery form, and size may be used. When the filament is passed over the heating element, the filament can be heated to a temperature above the object material's 223 glass transition temperature. The resulting flowable viscous plastic 223 may subsequently be forced out of print head 227 by a pressure source (not shown), and then extruded from the nozzle onto a build plate 229.

As the object material 223 filament thread is extruded, the head assembly 227 may be moved relative to the build plate 229 to lay down the extruded filament bead. The extruded bead may harden on cooling to produce a required shape of the object 206. In some embodiments, the build plate 229 may be raised and lowered vertically to form objects 206 (and isolation layers 209) by successive layers deposited by the head assemblies 227 and 228.

The 3D printing environment 200 can also include a component 230 for separating the printed copies 206 and the isolation material 226. This component 230 is also referred to herein as a “separator”. The separator 230 may be a stand-alone/external component or may be integrated into the 3D printer 220. In some embodiments, the separator 230 may include a solvent (e.g., water or an organic solvent), an energy source (e.g., source of mechanical, thermal, or electromagnetic energy.), robotic arm(s), gravity, or a combination thereof (e.g., a water jet or an ultrasonic bath).

The 3D printing environment 200 may include various separators 230 from which to select. The separator 230 may be selected based, at least in part, on the type of isolation material 226. This is discussed in greater detail below. The selection may be included in the layout plan 216 instructions sent to the controller 219 in some embodiments. There may be a separation chamber (not shown) in which the separator 230 is applied to the printed objects 206 and isolation layers 209. However, the separator 230 may be employed in situ (e.g., while the printed materials 206-N and 226 are in a printing chamber of 3D printer 220) or in any appropriate location.

In other embodiments, the separator 230 may be omitted from the 3D printing environment 200. For example, the printed objects 206 may be separated manually. In another example, if the isolation layers 209 do not adhere to the objects and are easily removed, the additional component 230 for separation may be unnecessary.

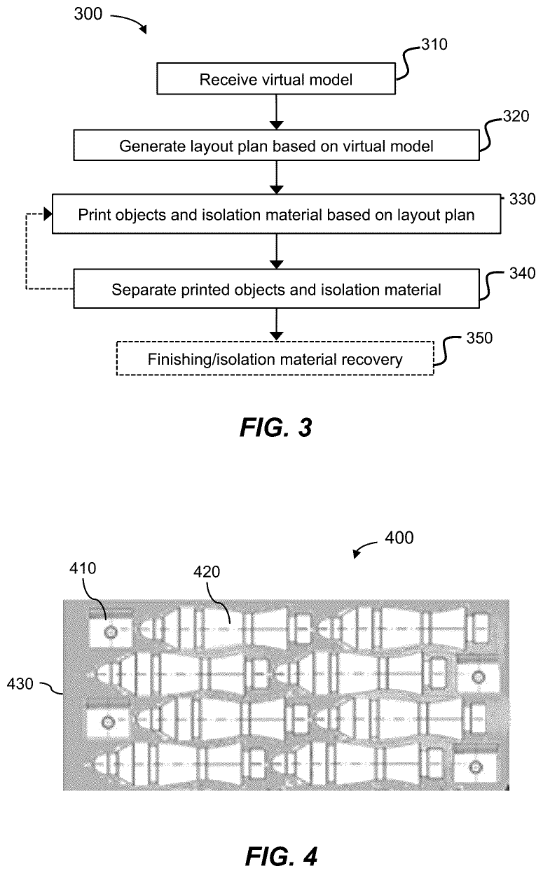

FIG. 3 is a flowchart illustrating a process 300 of printing an arrangement of 3D objects separated by isolation layers, according to some embodiments. Process 300 may be carried out using components such as those shown in the 3D printing environment 200 of FIG. 2 and, for illustrative purposes, is discussed with reference to FIG. 2. Process 300 can include at least one print cycle. Herein, a “print cycle” refers to a process of printing one set of copies of an object or objects.

A virtual model of an object or objects can be received by a design module 213. This is illustrated at operation 310. For example, the virtual model 203 illustrated in FIG. 2 may be received. In some embodiments, virtual models of more than one object can be received at operation 310 (see, e.g., FIG. 4). The design module 213 can then generate a layout plan 216 for printing N copies of the object(s). This is illustrated at operation 320.

The layout plan 216 can include instructions for arranging the objects 206 and isolation layers 209 to be printed with the smallest possible/practical gaps between objects. For example, the arrangement may include a vertical stack of the objects 206 separated by thin layers 209 of the isolation material 226. The minimum gaps may be determined based on the virtual model 203, predicted stability of the printed arrangement, capability/features of the manufacturing technique to be employed, etc. The predicted stability may be determined based on parameters such as structure (e.g., object dimensions, center of mass, etc.) material(s) to be printed (e.g., object material 223 and isolation material 226), number of copies, etc. The layout plan 216 can include the above instructions, a virtual 3D model (not shown) of the arrangement to be printed in each print cycle, and/or any other instructions/parameters necessary for printing the objects 206.

The layout plan 216 can indicate how many copies of the object 206 are to be printed. Multiple copies may be stacked in sequence in a spatially optimal way determined by the design module 213 to achieve denser packing and ease of separation in subsequent method steps. For example, asymmetrically shaped objects may be arranged in alternating directions. The layout plan 216 can also be optimized based on the dimensions and available space at the build plate 229 in the 3D printer 220.

A set of objects 206 and isolation layers 209 can be printed according to the layout plan 216. This is illustrated at operation 330. The controller 219 may receive the layout plan 216 and direct the 3D printer 220 to print the copies 206 and isolation layers 209 at operation 330. An example of a 3D-printed arrangement that may be formed at operation 330 is illustrated in FIG. 4. At least one copy of an object may be printed with the primary material 223 before an isolation layer is deposited. However, isolation material 226 may be printed on the build plate of 3D printer before beginning to print the primary material 223 in some embodiments.

In some embodiments, one head assembly 227 or 228 prints at a time, alternating between printing objects and isolation layers at operation 330. Isolation material 226 may be applied on a completed object while a next object is being printed. There may also be additional print head assemblies for simultaneous/parallel printing (not shown). For example, more than one object can be printed in parallel at operation 330 with more than one printer head assembly depositing object materials 223. In some embodiments, the isolation material 226 may be deposited simultaneously on multiple objects 206, e.g., on a top of a row of objects (not shown). In further embodiments, more than one material (e.g., from additional print head assemblies) may be used to form at least one of the objects 206 and/or at least one of the isolation layers 209.

In some embodiments, the objects 206 and isolation layers 209 may be formed using different techniques. For example, the first head assembly 227 may be a different type of head assembly than the second 228 (e.g., where one extrudes a plastic filament while the other deposits a powder). In further embodiments, the isolation material 226 may be laid over objects (e.g., as a film, plate, or sheet), deposited as a liquid or aerosol, spread in a thin layer or dusted over the objects 206, etc. In some embodiments, isolation material 226 may be injected as needed for additional support.

When the print cycle is completed, the printed objects 206 can be separated. This is illustrated at operation 340. Operation 340 may be carried out using the separator 230, as discussed above with respect to FIG. 2. For example, the separator 230 may be a source of ultrasonic vibrations, which can be applied to ABS objects 206 printed between polyvinyl alcohol (PVA) isolation layers 209 at operation 330. In another example, polylactic acid (PLA) objects 206 may be printed between PVA isolation layers 209 at operation 330 and separated by a water jet 230 at operation 340. Additionally, nylon objects 206 may be printed between calcium carbonate isolation layers 209 and separated by a separator 230 that applies both ultrasonic vibrations and a water jet. Further, operation 340 may include applying a water jet to polycarbonate objects 206 printed between calcium carbonate isolation layers 209.

If additional objects are to be printed in a next print cycle, operation 330 may be repeated during or after operation 340. A next print cycle may begin automatically in some embodiments. For example, if the size of the 3D printer 220 will not allow the total number N of objects 206 to be printed in one cycle, additional cycles may be carried out. Between print cycles, the printed objects 209 may be removed robotically, by a conveyor belt or movable build plate 229, manually, etc.

After separating the objects 206 and isolation layers 209 at operation 340, optional finishing processes may be carried out. This is illustrated at operation 350. For example, the objects 206 may be cleaned to remove any residual isolation material 226 from the isolation layers 209. Additionally, the separated isolation layers 209 may be collected as intact pieces, a powder, a solution or suspension, etc., depending upon the isolation material 226 and separator 230 used at operation 340. At operation 350, the collected isolation layers 209 may be discarded or reused as, e.g., isolation material 226 in subsequent print cycles.

FIG. 4 is a pictorial diagram illustrating an arrangement 400 of printed objects and isolation material, according to some embodiments. In FIG. 4, multiple copies of two types of objects are shown, and one object of each type is labeled (objects 410 and 420). The objects are positioned in an isolation structure 430 formed by printing isolation material 226. The shape of the isolation structure 430 may fill the negative space around the objects 410 and 420 so that each object is supported while being laid down in the orientation specified by the layout plan 216. Additionally, the isolation structure 430 can isolate the printed objects 410 and 420 by preventing formation of physical or chemical bonds between adjacent objects. The arrangement 400 may be printed at operation 330 of process 300.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

Various aspects of the present disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method, comprising:
generating, by a computer-implemented design module, a layout plan for printing three-dimensional (3D) objects, wherein the generating the layout plan comprises:
receiving a virtual model representing the objects;
selecting, by the design module, an object material for printing the objects;
selecting, based on the object material and the virtual model, an isolation material to be deposited on adjacent surfaces of the objects to separate them; and
generating a virtual model arrangement of the objects and the isolation material; and
providing the layout plan to a controller of a 3D printer, wherein the controller directs the 3D printer to print an arrangement of the objects and the isolation material according to the layout plan.

2. The method of claim 1, further comprising removing the objects from the arrangement.

3. The method of claim 2, wherein the removing comprises dissolving the isolation material.

4. The method of claim 2, wherein the removing comprises applying ultrasonic vibrations to the printed arrangement.

5. The method of claim 2, further comprising:
collecting the isolation material remaining after the removing; and
reusing the isolation material in a next print cycle.

6. The method of claim 2, wherein the removing comprises applying a water jet to the printed arrangement.

7. The method of claim 1, wherein the isolation material is selected from the group consisting of polyvinyl acetate and calcium carbonate.

8. The method of claim 1, wherein the object material is a thermoplastic.

9. The method of claim 1, wherein the generating the virtual model arrangement comprises selecting, based on a predicted stability, a number of the objects to be printed in a vertical stack.

10. The method of claim 1, wherein the generating the virtual model arrangement comprises determining, by the computer-implemented design module, centers of mass of the objects.

11. The method of claim 1, wherein:
the objects are printed by a first printer head assembly of the 3D printer; and
the isolation material is printed by a second printer head assembly of the 3D printer.

12. The method of claim 11, wherein the layout plan comprises instructions for printing, by the second printer head assembly, the isolation material on a first portion of the objects while simultaneously printing, by the first printer head assembly, a second portion of the objects.

13. The method of claim 1, wherein the object material is acrylonitrile butadiene styrene, and the isolation material a layer of polyvinyl acetate.

14. The method of claim 1, wherein the isolation material is a powder.

15. The method of claim 1, wherein the isolation material forms a support structure for the objects in the arrangement.

16. A system, comprising:
a three-dimensional (3D) printer;
a memory; and
a processor communicatively coupled to the memory, wherein the processor is configured to perform a method comprising:
generating, by a computer-implemented design module, a layout plan for printing 3D objects, wherein the generating the layout plan comprises:
receiving a virtual model representing the objects;
selecting, by the design module, an object material for printing the objects;
selecting, based on the object material and the virtual model, an isolation material to be deposited on adjacent surfaces of the objects to separate them; and
generating a virtual model arrangement of the objects and the isolation material; and
providing the layout plan to a controller of the 3D printer, wherein the controller directs the 3D printer to print an arrangement of the objects and the isolation material according to the layout plan.

17. The system of claim 16, wherein the generating the virtual model arrangement comprises selecting, based on a predicted stability, a number of the objects to be printed in a vertical stack.

18. The system of claim 16, wherein the controller further directs the 3D printer to:
obtain, by a robotic arm, the printed arrangement of the objects and the isolation material; and
remove, by a separator, the objects from the arrangement.

19. A computer program product, the computer program product comprising a computer readable storage medium having program instructions embodied therewith, the program instructions executable by a processor communicatively coupled to a memory to cause a device to perform a method, the method comprising:
generating, by a computer-implemented design module, a layout plan for printing three-dimensional (3D) objects, wherein the generating the layout plan comprises:
receiving a virtual model representing the objects;
selecting, by the design module, an object material for printing the objects;
selecting, based on the object material and the virtual model, an isolation material to be deposited on adjacent surfaces of the objects to separate them; and
generating a virtual model arrangement of the objects and the isolation material; and
providing the layout plan to a controller of a 3D printer, wherein the controller directs the 3D printer to print an arrangement of the objects and the isolation material according to the layout plan.

20. The computer program product of claim 19, wherein the controller further directs the 3D printer to:
obtain, by a robotic arm, the printed arrangement of the objects and the isolation material; and
remove, by a separator, the objects from the arrangement.
